(19) United States
(12) Patent Application Publication
(10) Pub. No.: US 2009/0154141 A1
(43) Pub. Date: Jun. 18, 2009

(54) LIGHT GUIDE PLATE AND BACKLIGHT MODULE

(76) Inventor: Tsung-Ming Hsiao, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/126,999

(22) Filed: May 26, 2008

(30) Foreign Application Priority Data
Dec. 18, 2007 (TW) 096148415

(51) Int. Cl. G02F 1/13357; F21V 8/00

(52) U.S. Cl. 362/97.3; 362/326; 362/330

(57) ABSTRACT

A composite light guide plate contains a transparent plate and a transparent film. A plurality of V-cuts is formed on the light exit plane of the transparent plate, and a plurality of protrudent micro structures is disposed on the bottom surface of the transparent film, filling in the v-cuts. The refractive index of the transparent film is larger than the refractive index of the transparent plate.

### BACKGROUND OF THE INVENTION

1. Field of the Invention

The present invention relates to a backlight module, and more specifically, to a backlight module having a composite light guide plate.

2. Description of the Prior Art

The backlight module is one of the key components of a plate display device (ex: liquid display device). At the moment, the backlight module is generally applied on the digital camera, the mobile phone, the personal digital assistant (PDA), the computer monitor, the plate television and so on. In general, the backlight module is set on the back of the display panel and comprises a light source, a light guide plate (LGP), a diffuser sheet and several kinds of optical films or a prism sheet. The light guide plate is used for scattering the light generated by the light source to provide a plate-like light source. The diffuser sheet is used for diffusing the light uniformly. The optical films or the prism sheet are set above the diffuser sheet for increasing the brightness and the homogeneity.

The backlight modules can be roughly separated into two kinds of designs: “direct-underlying” and “edge light”. The light source is set on the back of the direct-underlying backlight module. Because the assembly space is quite large, more than two tubes can be used for increasing the light intensity. As a result, display panels of larger size or higher brightness, such as the outdoor/high brightness LCD monitor or the LCD television, is suitable for utilizing the direct-underlying backlight module as the light source generator. The light source of the edge light backlight module is set on the side of the display panel for reducing the depth of the display panel. Since the edge light backlight module provides advantages of light, thin and power saving, it is mostly applied to the LCD devices of mobile electronic products.

Referring to FIG. 1, FIG. 1 is a sectional diagram of the structure of an edge light backlight module 10 according to the prior art. The backlight module 10 has a light guide plate 12, a down diffuser sheet 14, a down prism sheet 16, an up prism sheet 18, and an up diffuser sheet 20. In addition, the backlight module 10 further has a light source 22 set at a side of the light guide plate 12, wherein the light source 22 may be a light emitting diode (LED). The light emitted from the light source 22 is guided by the light guide plate 12, propagating into the down diffuser sheet 14. The micro structures disposed on the surface of the down diffuser sheet 14 are capable of scattering light so as to provide uniform light. After passing through the down diffuser sheet 14, light will enter the down prism sheet 16 and the up prism sheet 18, whose prism patterns are disposed perpendicularly with each other to gather up dispersed light for reducing lose of light and increasing the brightness of light provided by the backlight module 10. Thereafter, light will enter the up diffuser sheet 20, where it will be dispersed again and propagate out from the light exit plane of the up diffuser sheet 20 to enter the display panel for providing backlight source.

Therefore, the backlight module 10 has to include at least two to four optical films or sheets, such that the prior-art backlight module 10 has disadvantages of long assembly time and high process cost. In addition, since light has to pass through many optical films or prism sheets before it reaches the display panel, its energy and the utility efficiency are both reduced. As a result, how to provide a backlight module with a simple structure and high brightness is still an important issue for the manufacturers of backlight modules.

### SUMMARY OF THE INVENTION

It is a primary objective of the claimed invention to provide a composite light guide plate and a backlight module having said light composite guide plate, wherein the composite light guide plate is capable of increasing the ratio of light that emits from the backlight module along a direction perpendicular to exit plane of the backlight module. Therefore, the composite light guide plate may provide the functionalities of other optical films or sheets in the prior-art backlight module.

According to the claimed invention, a composite light guide plate is provided. The composite light guide plate comprises a transparent plate and a transparent film. The transparent plate has a light exit plane with a plurality of V-cuts thereon and a light entrance plane. The transparent film is disposed on the light exit plane of the transparent plate, and has a plurality of protrudent micro structures on its bottom surface corresponding to the V-cuts and filling in the V-cuts. The refractive index of the transparent film is larger than the refractive index of the transparent plate.

It is an advantage of the claimed invention that the composite light guide plate includes a transparent film with a high refractive index disposed directly on the transparent plate with a low refractive index so that a plurality of V-cut interfaces is disposed between the transparent plate and the transparent film, which changes the propagating path of light emitting out of the composite guide light plate. Accordingly, most light propagating to the protrudent micro structures will be totally reflected by the V-cut interfaces so as to exit perpendicularly from the composite light guide plate directly upward. Since the ratio of light emitting perpendicularly from the composite light guide plate is increased, the brightness and utility efficiency of light are also improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional diagram of the structure of an edge light backlight module according to the prior art.

FIG. 2 is a sectional schematic diagram of a backlight module according to a first embodiment of the present invention.

FIG. 3 is a directive characteristics diagram of an LED light source.

FIG. 4 is an enlarged diagram of a portion of the composite light guide plate shown in FIG. 2.

FIG. 5 is a top view of the backlight module shown in FIG. 2.

FIG. 6 to FIG. 8 are schematic diagrams of the backlight modules according to the second to fourth embodiments of the present invention.

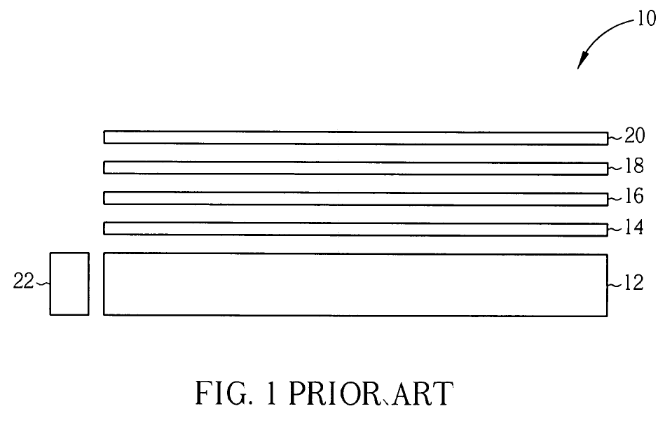

### DETAILED DESCRIPTION

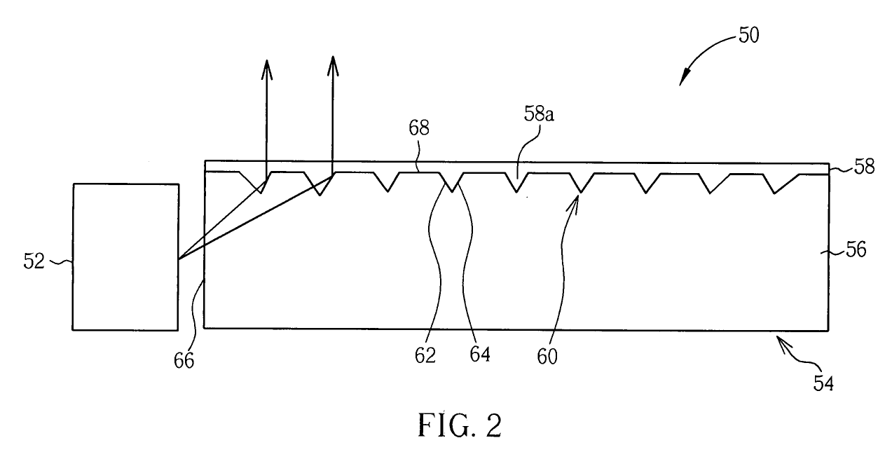

Referring to FIG. 2, FIG. 2 is a sectional schematic diagram according to a first embodiment of the present invention backlight module. The present invention backlight module 50 comprises at least a light source 52 and a composite light guide plate 54, wherein the light source 52 is a light emitting diode (LED). The composite light guide plate 54 comprises a transparent plate 56 and a transparent film 58. The transparent plate 56 has a refractive index n₁, and comprises transparent resin materials with high penetrability, such as polystyrene (PS), polycarbonate (PC), polyethylene terephthalate (PET), or Polymethyl methacrylate (PMMA). The transparent plate 56 has a light entrance plane 66 and a light exit plane 68, and the light exit plane 68 has a plurality of V-cuts 60 disposed on its surface, wherein each V-cut 60 is like a trench formed on the top surface of the transparent plate 56. Each V-cut 60 is composed of a first surface 62 and a second surface 64, wherein the first surface 62 is close to the light entrance plane 66 and the second surface 64 is far to the light entrance plane 66. The transparent film 58 has a refractive index n₂, which may comprises UV curing resin. The transparent film 58 is directly disposed on the light exit plane 68 of the transparent plate 56, and has a plurality of protrudent micro structures 58a on its bottom surface, corresponding to the V-cuts 60 respectively. Each protrudent micro structure 58a fills its corresponding V-cut 60. In addition, the refractive index n₂ of the transparent film 58 is larger than the refractive index n₁ of the transparent plate 56.

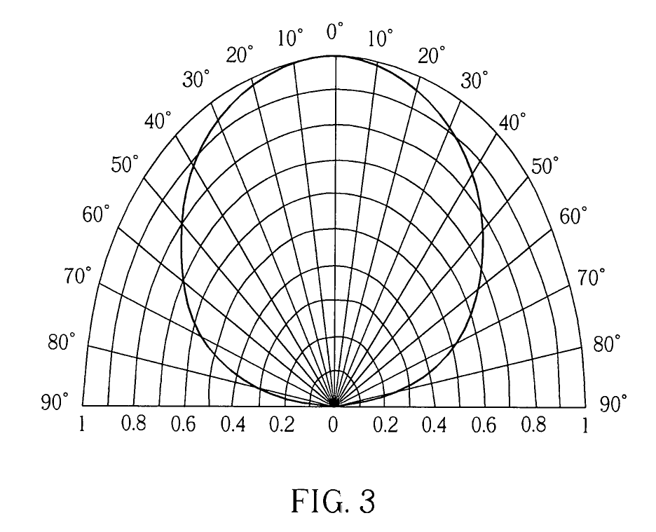

With reference to FIG. 3, FIG. 3 is a directive characteristics diagram of a usual LED. As shown in FIG. 3, the divergence angle of the LED light source 52 is about ±70° to ±80°. In order to effectively utilize the light emitted from the light source 52, the disposing directions of the first and second surfaces 62, 64 of the V-cuts 60 have to be specially designed so that most light can exit the composite light guide plate 54 upward directly.

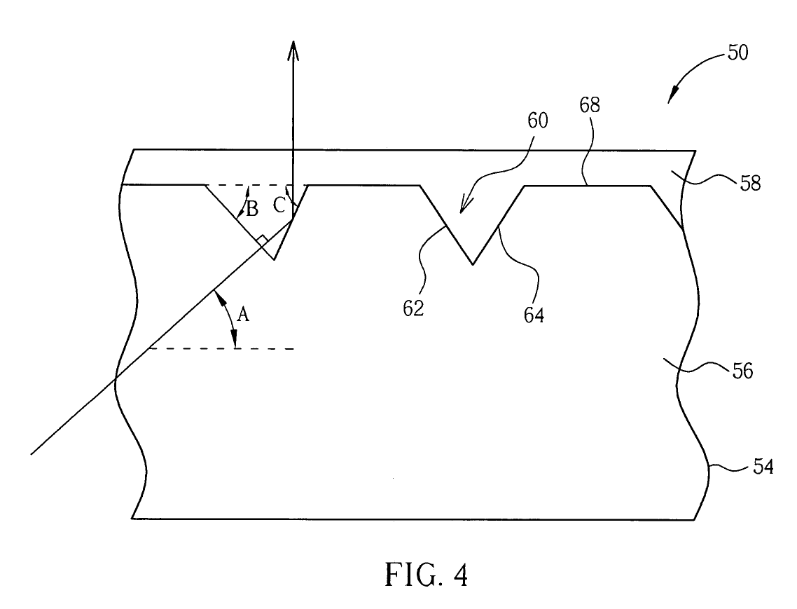

Please refer to FIG. 4. FIG. 4 is an enlarged diagram of a portion of the composite light guide plate 50 shown in FIG. 2. After the light produced by the light source 52 enters the transparent plate 56 through the light entrance plane 66, its propagating path has an included angle A with the light exit plane 68 or the bottom surface of the transparent plate 56, wherein the included angle A is defined as an incidence angle of the light. Generally, the incidence angle is the emergent angle of light emitting from the light source 52 (the light intensity proportion of each emergent angle is shown in FIG. 3). According to the design of the composite light guide plate 54 of the present invention, most light propagates out of the transparent plate 56 along a direction approximately perpendicular to the first surfaces 62 of the V-cuts 60 before entering the transparent film 58. When light reaches the second surfaces 64, its incident angle is larger than the critical angle of total reflection such that it will be refracted by the second surfaces 64 upward to emit out along the direction perpendicular to the light exit plane 68 and the top surface of the transparent film 58.

In order to make the propagating path of light have the above-mentioned characteristic, the included angles of the first surface 62 and second surface 64 of each V-cut 60 has a special design. As shown in FIG. 4, the first surface 62 and the second surface 64 have a first included angle B and a second included angle C with the light exit plane 68 respectively. Since light has to pass through the V-cuts 60 perpendicularly to the first surface 62 before entering the transparent film 58, the relation of the first included angle B and the incidence angle A of light must satisfy the equation: B≦(90°−A)≦90°. Furthermore, the second included angles C should be acute angles, and the relation of the second included angle C and the incidence angle A of light has to satisfy: C≦45°+A/2, such that light can be totally reflected by the second surfaces 64 to emit out from the light guide plate 54, with a direction perpendicular to the light exit surface 68. Because the divergence angle of the LED light source 52 is about ±70° to ±80°, the V-cuts 60 have various shapes with various included angles of the first surfaces 62 and the second surfaces 64 for matching the path of the incident light. In a preferable embodiment, one of the first included angles B far to the light entrance plane 66 is larger than another first included angle B which is closer to the light entrance plane 66, and one of the second included angles C far to the light entrance plane 66 is smaller than another second included angle C that is closer to the light entrance plane 66, as shown in FIG. 2.

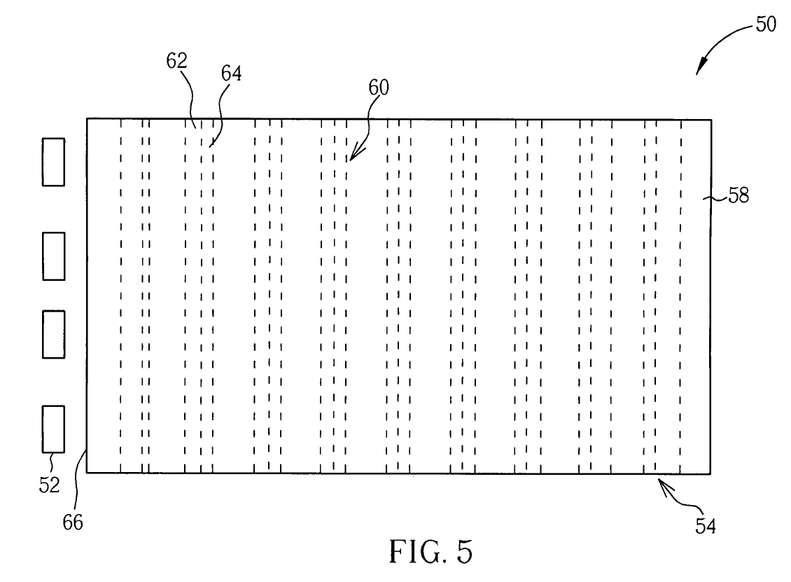

With reference to FIG. 5, FIG. 5 is a top view of the backlight module 50 shown in FIG. 2. V-cuts 60 are pluralities of strip grooves which extends from a sidewall of the light guide plate 54 to another sidewall of the light guide plate 54, wherein the strip grooves are parallel to the light entrance plane 66. FIG. 5 also shows that the first surfaces 62 closer to the light entrance plane 66 are larger than the first surfaces 62 farther to the light entrance plane 66, and the second surfaces 64 closer to the light entrance plane 66 are smaller than the second surfaces 64 farther to the light entrance plane 66. In other words, the farther the first included angle B to the light entrance plane 66, the larger the first included angle B is, and the farther the second included angle C to the light entrance plane 66, the smaller the second included angle C is.

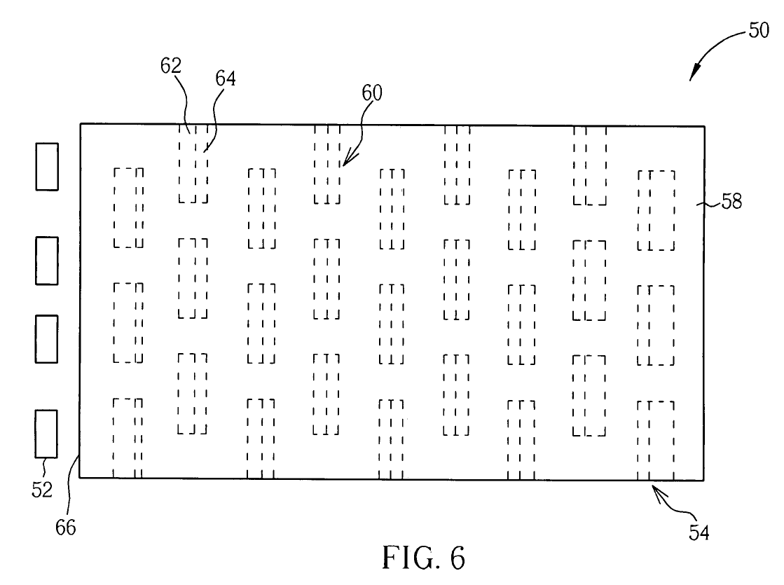

Please refer to FIG. 6. FIG. 6 is a top view of a backlight module according to a second embodiment of the present invention, wherein the same elements are presented by numerals used in FIG. 5. In this embodiment, the V-cuts 60 are rectangular strip grooves with shorter length than the V-cuts 60 in FIG. 5. Some of the V-cuts 60 are disposed at a same straight line parallel to the light entrance plane 66. However, in other embodiments of the present invention, the rectangular V-cuts 60 may be arranged randomly or staggeredly on the light exit plane 68 of the transparent plate 56, rather than the arrangement shown in FIG. 6 that all the V-cuts 60 are arranged at several straight lines regularly.

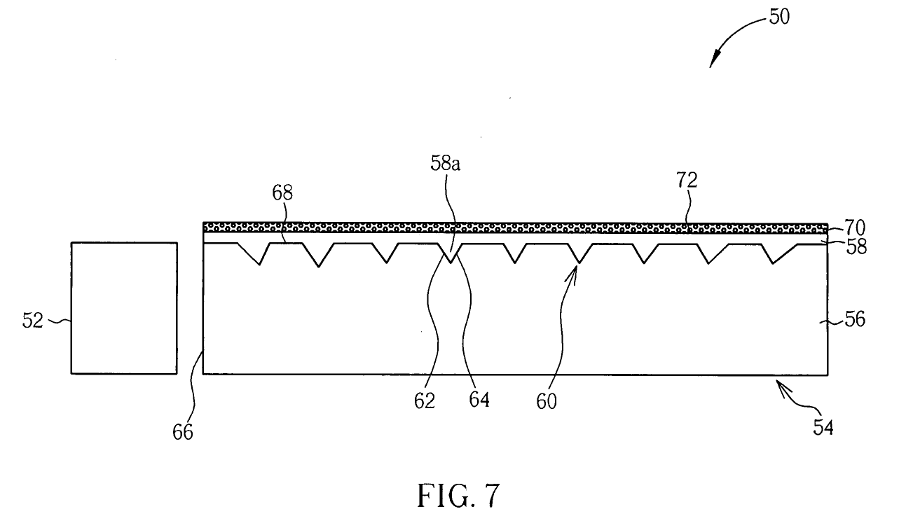

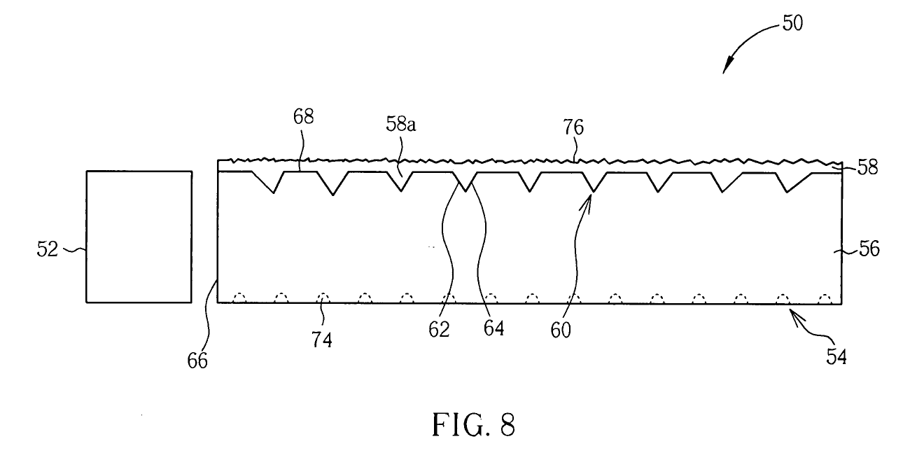

Referring to FIG. 7 and FIG. 8, FIG. 7 and FIG. 8 are sectional diagrams of a third and a fourth embodiments of the present invention backlight modules. Similarly, same elements are marked with the same numerals used in FIG. 2. According to the third embodiment of the present invention, the upper surface of the transparent film 58 further comprises a diffusion layer 70 so that the light emitted from the top surface of the transparent film 58 is further uniformly scattered by the diffusion layer 70. In a preferable embodiment, the diffusion layer 70 comprises a plurality of diffusion particles 72. Referring to FIG. 8, the composite light guide plate 54 according to the fourth embodiment of the present invention comprises a plurality of diffusion patterns 74 that diffuse or reflect the light that propagates to the bottom surface of the composite light guide plate 54 back into the transparent plate 56. In addition, the top surface of the transparent film 58 is a rough surface 76, which is capable of further scattering or diffusing the light to improve the uniformity of light. In other embodiments of the present invention, the backlight module 50 may further includes one to two optical films (not shown), such as prism sheets, disposed on the composite light guide plate 54 if needed.

In contrast to the prior art, the backlight module of the present invention comprises a special-designed composite light guide plate, which may provide the functions of the prism sheets or diffuser sheets in the prior-art backlight module. Therefore, the use of the optical films can be reduced in the backlight module so as to decrease the whole thickness and fabrication costs of the backlight module. In addition, according to the design of the present invention backlight module, since only one unity of composite light guide plate and the light source has to be assembled in the housing of the backlight module, the assemble hour can be saved and the assemble process is simplified. As a result, the fault resulted from the complexity of assembling pluralities of optical films at the same time in the prior art can be avoided. Furthermore, with compare to the prior-art backlight module, the light only passes less optical films or only one composite light guide plate before it emits the present invention backlight module, so that the loss of energy of light is less. As a result, the light utility efficiency can be effectively improved.

Those skilled in the art will readily observe that numerous modifications and alterations of the device and method may be made while retaining the teachings of the invention.

What is claimed is:

1. A composite light guide plate, comprising:
a transparent plate having a light exit plane and a light entrance plane, the light exit plane having a plurality of V-cuts; and
a transparent film disposed on the light exit plane of the transparent plate, the transparent film having a plurality of protrudent micro structures on an bottom surface of the transparent film, each of the protrudent micro structures corresponding to one of the V-cuts and filling the corresponding V-cut, the refractive index of the transparent film is larger than the refractive index of the transparent plate.

2. The composite light guide plate of claim 1, wherein each of the V-cuts has a first surface close to the light entrance plane and a second surface far to the light entrance plane to form the V-cut, the first surface has a first included angle B with the light exit plane, and the second surface has second included angle C with the light exit plane.

3. The composite light guide plate of claim 2, wherein an included angle of the light exit plane and a path of light passing into the transparent plate through the light entrance plane is defined as an incidence angle A, and A and B satisfies: B≦(90°−A)≦90°.

4. The composite light guide plate of claim 2, wherein an included angle of the light exit plane and a path of light passing into the transparent plate through the light entrance plane is defined as an incidence angle A, and A and C satisfies: C≦45°+A/2.

5. The composite light guide plate of claim 2, wherein one of the first included angles is larger than another of the first included angles that is closer to the light entrance plane.

6. The composite light guide plate of claim 2, wherein one of the second included angles is smaller than another of the second included angles that is closer to the light entrance plane.

7. The composite light guide plate of claim 2, wherein the second included angles are acute angles so that light passes from the light entrance plane to the second surfaces is totally refracted and propagates out through a top surface of the transparent film.

8. The composite light guide plate of claim 2, wherein light passing into the transparent plate from the light entrance plane propagates into the transparent film through the first surface perpendicularly.

9. The composite light guide plate of claim 1, wherein the V-cuts are pluralities of strip grooves parallel to the light entrance plane.

10. The composite light guide plate of claim 1, wherein some of the V-cuts are disposed at a straight line, and the straight line is parallel to the light entrance plane.

11. The composite light guide plate of claim 1, wherein the transparent film has a rough top surface.

12. The composite light guide plate of claim 1, wherein the transparent film further comprises a diffusion layer set on a top surface of the transparent film.

13. The composite light guide plate of claim 12, wherein the diffusion layer comprises a plurality of diffusion particles disposed therein.

14. The composite light guide plate of claim 1, wherein a bottom surface of the transparent plate comprises a plurality of diffusion patterns.

15. The composite light guide plate of claim 1, wherein the transparent plate comprises materials of polystyrene (PS), polycarbonate (PC), polyethylene terephthalate (PET), or polymethyl methacrylate (PMMA).

16. The composite light guide plate of claim 1, wherein the transparent film comprises a material of UV curing resin.

17. A backlight module, comprising:
a composite light guide plate of claim 1; and
at least a light source disposed on a surface of the light entrance plane.

18. The backlight module of claim 17, wherein the light source is a light emitting diode (LED).
